(19) United States
(12) Patent Application Publication
(10) Pub. No.: US 2005/0271886 A1
(43) Pub. Date: Dec. 8, 2005

(54) Oxidation resistant superalloy and article

(76) Inventor: Alan D. Cetel, West Hartford, CT (US)

Correspondence Address: PRATT & WHITNEY, 400 MAIN STREET, MAIL STOP: 132-13, EAST HARTFORD, CT, 06108, US

(21) Appl. No.: 11/089,392

(22) Filed: Mar. 24, 2005

Related U.S. Application Data
(63) Continuation-in-part of application No. 09/699,945, filed on Oct. 30, 2000, now abandoned.

(51) Int. Cl. B32B 9/00

(52) U.S. Cl. 428/472

(57) ABSTRACT

An oxidation resistant, nickel base superalloy is described. The combination of alloy and a thermal barrier coating can be used to fabricate turbine components with good high temperature strength and good oxidation resistance, while maintaining other relevant properties.

### CROSS REFERENCE TO RELATED APPLICATION

This application is a continuation in part of co-pending and commonly owned U.S. Ser. No. 09/699,945 entitled “Low Density Oxidation Resistant Superalloy Materials Capable of Thermal Barrier Retention Without a Bond Coat”, filed on Oct. 30, 2000 and which is expressly incorporated by reference herein.

### BACKGROUND OF THE INVENTION

As gas turbine engines have evolved, the requirements placed on the superalloys which form the operating components of such turbines have increased. Early gas turbine engines used polycrystalline cast turbine airfoils without protective coatings. Over time, improved mechanical properties were obtained by casting superalloy articles in a columnar grain form comprising elongated grains whose direction of elongation is at least generally in the direction of the major stress axis. This technique reduces the number of transverse grain boundaries and improves the mechanical properties of the components. Also, starting at about this time it became common to use protective coatings to protect the components from oxidation and corrosion.

The next step in the evolution of gas turbine components was the development of single crystals. Single crystals are free from internal grain boundaries and offer an increased level of mechanical properties. Single crystal alloys were developed for use at higher temperatures, and in many cases utilized protective coatings. Single crystal alloys and articles are described, for example, in commonly owned U.S. Pat. Nos. 4,209,348, 4,459,160 and 4,643,782. Depending upon the particular operating conditions for parts comprising these alloys, such articles provide an acceptable level of oxidation resistance.

In one effort to improve oxidation resistance and lower weight, commonly owned EP1201778 entitled “Low Density Oxidation Resistant Superalloy Materials Capable of Thermal Barrier Retention Without a Bond Coat”, shows an alloy suitable for use with a thermally insulating ceramic, and with or without a bond coat. The '778 publication application discloses alloys including small but controlled additions of hafnium and yttrium to nickel based superalloys. These small additions result in large improvements to certain properties including oxidation resistance. However, the addition of yttrium to alloys cast as hollow articles, e.g., cooled turbine components, typically requires the use of alumina core materials as part of the investment casting process, which core materials can be costly to fabricate and/or difficult to remove from the as-cast articles. Moreover, the use of both hafnium and yttrium lowers incipient melting temperature of the alloy, making it more difficult to fully solution heat treat the alloy, which reduces the creep strength of the alloy.

It would be desirable to provide a directionally solidified alloy, such as a single crystal alloy, with improved properties such as improved oxidation resistance, while maintaining other relevant properties such as creep, stress corrosion resistance, low cycle fatigue resistance and including castability at a comparable level.

### SUMMARY OF THE INVENTION

The present invention comprises a nickel base superalloy, which is suitable for use in columnar grain and single crystal articles. The superalloy exhibits increased uncoated and coated oxidation resistance to other alloys having similar composition, while maintaining comparable other mechanical properties. A combination of this nickel base superalloy and a thermal barrier coating system includes a metallic bond coat capable of forming a durable adherent alumina scale formed on the substrate and a ceramic thermal barrier layer applied to the alumina scale.

The invention has particular utility in gas turbine applications, particularly rotating parts such as gas turbine blades. Such blades generally comprise an airfoil portion and a root or attachment portion.

### BRIEF DESCRIPTION OF THE DRAWINGS

FIG. 1 shows the relative coated and uncoated oxidation life of the inventive alloy.

FIGS. 2 and 3 show the creep rupture characteristics of the inventive alloy.

FIG. 4 shows the LCF characteristics of the inventive alloy.

### DESCRIPTION OF THE PREFERRED EMBODIMENTS

Advanced superalloy compositions have been developed which exhibit improved strength and high temperature capabilities. The present invention relates to hafnium, without intentional addition of yttrium, to certain nickel based superalloys yields significant improvements in oxidation resistance (comparable to that achieved with adding hafnium and yttrium), while maintaining castability and other relevant properties.

TABLE I
Alloy Composition Range in wt. %

| | EP Publ. | U.S. Pat. | | |
|---|---|---|---|---|
| | No. | No. | | |
| | EP1201778 | 4,209,348 | Invention A | Invention B |
| Cr | 6-13 | 8-12 | 7.5-12.5 | 9-11 |
| Al | 4.5-7 | 4.5-5.5 | 4.5-5.5 | 4.75-5.25 |
| Ti | .5-2.5 | 1-2 | up to 2 | 1-2 |
| W | 3-12 | 3-5 | 3.5-4.5 | 3.5-4.5 |
| Ta | 0-14 | 10-14 | 11.5-12.5 | 11.5-12.5 |
| Co | 0-15 | 3-7 | 3-16 | 4-6 |
| Hf | 0.05-1.5 | none | .2-.5 | .25-.45 |
| Y | .003-.040 | none | no | <.0005 |
| | | | intentional | |
| | | | addition, | |
| | | | <.003 | |
| Ni | Bal | Bal | Bal | Bal |
| Zr | 0-0.15 | <50 ppm | up to 0.05 | up to 0.05 |
| Nb | 0-2 | none | up to 8.5 | up to 8.5 |
| Mo | 0-4 | none | total | selected |
| Re | 0-1 | none | | from |
| V | 0-2 | none | | the group |
| | | | | comprising |
| | | | | up to 5 Mo, |
| | | | | up to 3 Re, |
| | | | | up to 1.5 |
| | | | | V, and up |
| | | | | to 3 Nb |
| Zr | 0-0.15 | <50 ppm | up to 0.05 | up to 0.05 |
| C | 0-0.1 | <50 ppm | up to 0.05 | up to 0.05 |
| B | 0-0.05 | <50 ppm | up to 0.005 | up to 0.005 |

Table I shows preferred ranges for alloys, the first of which is discussed in more detail in co-pending and commonly owned EP Publication No. EPI 201 778 (corresponding to the '945 application), the second of which is discussed in more detail in U.S. Pat. No. 4,209,348 and the last two of which are variations of the alloy of the present invention. These ranges include compositions suited for producing equiaxed grain, columnar grain and single crystal articles. These preferred ranges are optimized for single crystal applications. For single crystal applications, it is preferred that C be less than about 0.05%, B be less than about 0.005% and Zr be less than about 0.1% Preferably the ranges in Table f are subject to the constraint that a (Al+Ti+0.2 Ta) value is from about 6.5% to about 11.5% and more preferably from about 7.0% to about 10.5%; while the value for (W+0.8 Ta) is from about 9.5% to about 17.5% and more preferably from about 10.5% to about 16.5%. in the case of the inventive alloys, it is preferred that there be no yttrium, and in any case less than 100, more preferably less than 50 ppm.

An aspect of the present invention is the discovery that adding small, carefully controlled amounts of hafnium, without adding yttrium, to these alloys substantially improves their coated and uncoated oxidation resistance. Moreover, avoiding the use of intentional addition of yttrium enables the use of conventional, non-alumina core materials for the production, e.g., by investment casting, of hollow articles. In addition, the removal of yttrium from the alloy facilitates the solution heat treatment of cast articles to the extent that an absence of yttrium raises the incipient melting temperature of the alloy.

U.S. Pat. No. 4,719,080 defines broad ranges for nickel base superalloys and describes a quantity called the P parameter, which defines a desired relationship between various elements to produce an optimum combination of properties with a focus on high creep strength. The P parameter in U.S. Pat. No. 4,719,080 is repeated below:
P=−200 Cr+80 Mo²−250 Ti²−50 (Ti×Ta)+15 Cb+200 W−14 W²+30 Ta−1.5 Ta²+2.5 Co+1200 Al−100 Al²+100 Re+1000 Hf−2000 Hf²+700 Hf³−2000 V−500 C−15000 B−500 Zr.

The minimum P parameter disclosed in U.S. Pat. No. 4,719,080 for an alloy having high strength capability is 3360 and the maximum P parameter disclosed in that patent is 4700. Thus the compositions which are the focus of the present invention are distinguishable from those in U.S. Pat. Nos. 4,209,348 and 4,719,080 among other ways by the P parameter, alloying elements and certain properties, and from the '945 application by the absence of yttrium while maintaining comparable oxidation resistance and creep capability. Broadly to achieve the desired combination properties for the inventive alloy, the P parameter should be less than about 2500, or more preferably less than about 1800.

While the P parameter is a good indicator/predictor of superalloy creep-rupture properties, achieving a sufficiently high P parameter generally requires that heavy alloying elements be utilized. The resultant increase in alloy density leads to increased centrifugal forces during operation, without a concurrent improvement in LCF capability thereby effectively negating some of the improved creep properties which result from a high P parameter. As is the case in EP application 1 201 778, the invention alloys have lower levels of heavy alloying elements than current high strength alloys such as those set forth in the '080 patent, and therefore are less dense and develop lower centrifugal stresses than alloys with higher P parameters.

Samples of the inventive alloys were cast, and then heat treated. The heat treat included (i) heating to 2300-2370 F (in some cases 2335 F and in others 2325 F) for 0.5 hr min., cool to 2100 F at a rate of 115 F/min or faster, cool to below 800 F at a rate equivalent to air cool or faster, (ii) heat to ˜1975 F and hold for 4 hr and cool, and then (iii) heat to 1600 F and hold for 32 hr, then cool.

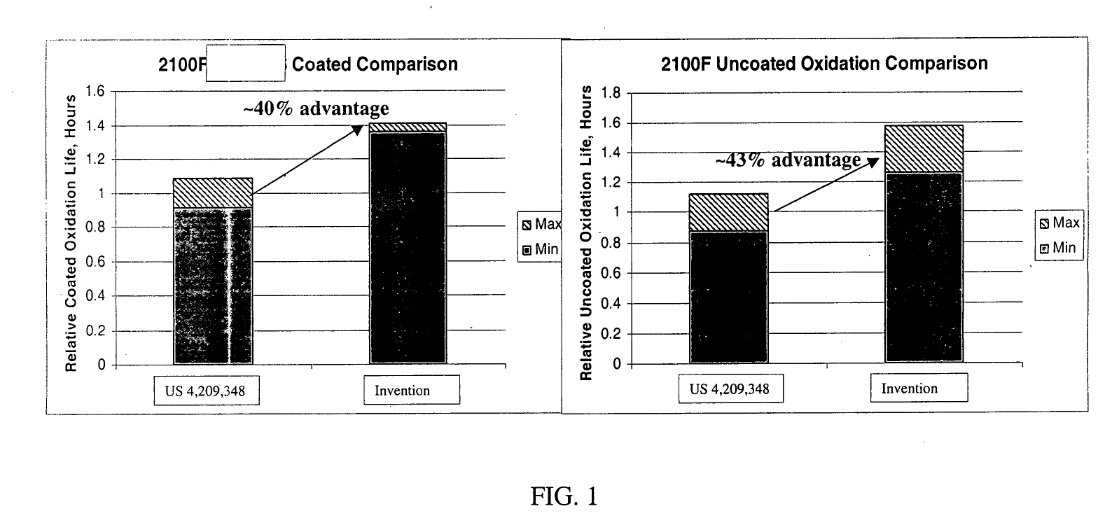

The present invention alloy displays substantial uncoated and coated oxidation resistance. Several sets of samples were tested in a burner rig cyclic oxidation test, four minutes in a 2100 F flame followed by two minutes of forced air cooling. The samples were single crystal samples of material described in U.S. Pat. No. 4,209,348, and single crystal samples of Preferred composition, Table I, above, with 0.35% Hf and no intentional addition of Y (less than 100 ppm) prepared as described above. With reference to FIG. 1, some samples were uncoated and some were coated with a corrosion and oxidation resistant coating material set forth in U.S. Pat. No. 4,585,481. In each case, the test results were 100% oxidation life for the samples of the '348 composition, and 140% relative oxidation life for the samples of the inventive composition (about a 40% improvement for coated samples and about a 43% improvement for uncoated samples). Thus, it can be seen that the oxidation life of the invention is significantly better than the '348 patent.

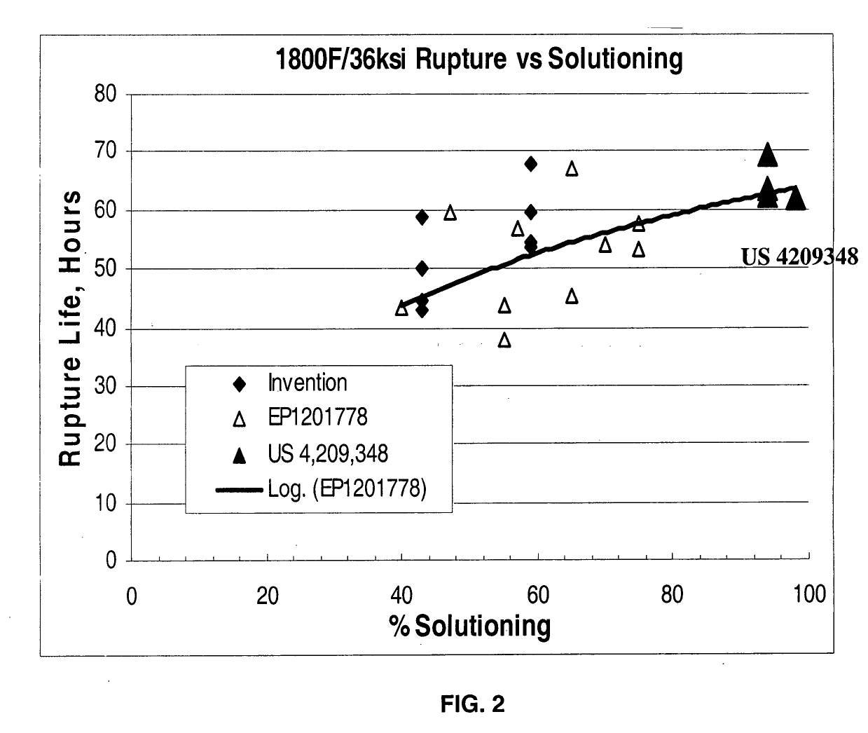

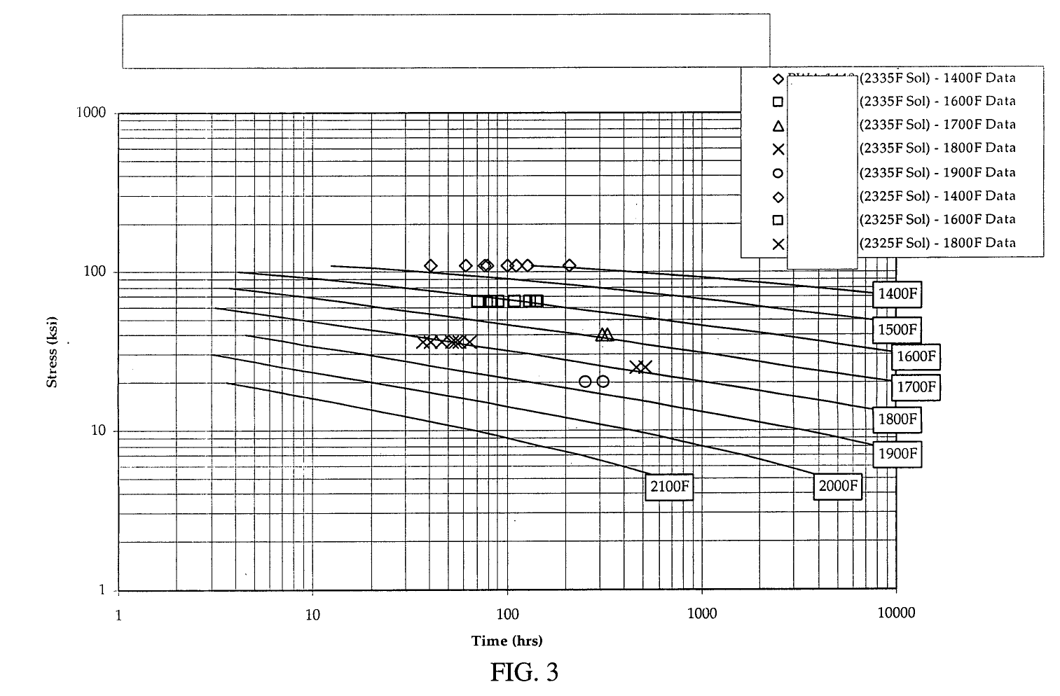

Those skilled in the art will recognize that other properties are relevant as well. For example, creep rupture behavior of the inventive alloy (nominal composition) were tested against those of EP application 1 201 778. During the test, a stress of 36 ksi was applied to test specimens at 1800 F, and the specimens were tested to failure. The results as illustrated in FIGS. 2 and 3 indicate that the inventive alloys are at least as creep rupture resistant, and benefit substantially from a slightly higher (˜10 F) solution heat treatment cycle that is difficult to apply to a similar alloy which also included yttrium, e.g., the alloy of EP 1 201 778.

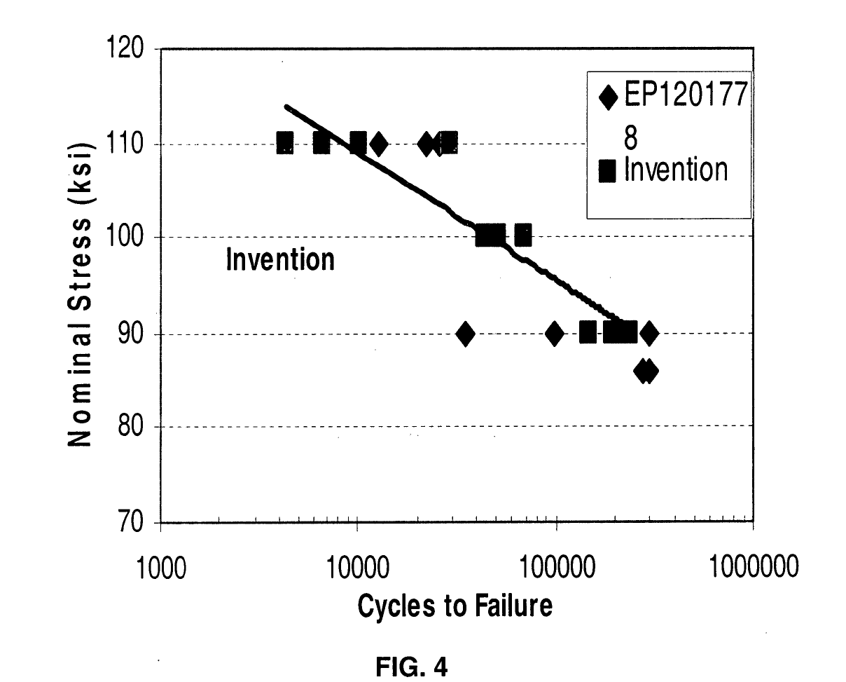

With respect to turbine blades in particular, the present invention alloy exhibits good LCF properties. FIG. 4 shows results of samples of the inventive alloy and those of the EP publication alloys, tested at 1200 F and various stress levels. As shown in the FIG. the inventive alloy are comparable to those of the EP publication alloy. In addition, samples of the inventive alloy were tested for resistance to stress corrosion, relative to samples of the alloy of EP publication 1 201 778, and the samples showed similar resistance to stress corrosion cracking.

The inventive alloys may be coated with a material designed to form an adherent alumina coating, upon which a ceramic insulating layer may be applied. While the present invention is illustrated in the context of a turbine blade, the present invention is not limited to any particular component. The overlay coating is preferably an MCrAlY coating, where M is cobalt, nickel, iron or combinations of these materials, although other overlay coatings such as MCr and MCrAl coatings may also be employed. Exemplary coatings useful with the present invention include at least NiCrAlY, CoCrAlY, NiCoCrAlY and CoNiCrAlY coatings. The coating may also include other elements such as Hf and Si to provide further improvements in oxidation or corrosion resistance. A summary of exemplary overlay coating compositions is shown below.

| | Coating Composition (wt %) | | | | | | |
|---|---|---|---|---|---|---|---|
| Specified Range | Ni | Co | Cr | Al | Y | Si | Hf |

| | | | | | | |
|---|---|---|---|---|---|---|
| Typical | Bal. | 10-40 | 5-35 | 0-2 | 0-7 | 0-2 |
| Preferred | Bal. | 20-40 | 5-20 | 0-1 | 0-2 | 0-1 |
| Exemplary | Bal. | 25-40 | 5-15 | 0-0.8 | 0-0.5 | 0-0.4 |

The overlay coating may be applied by various processes known to those skilled in the art, such as by vapor deposition (including electron beam physical vapor deposition, sputtering, cathodic arc, etc.) or thermal spray (air plasma spray, low pressure or vacuum plasma spray, high velocity oxy-fuel, etc.).

In the alternative, the coating may comprise an aluminide coating of the type well know in the art. The aluminide may include one or more noble metals, and may be applied by any of a variety of known application processes, e.g., vapor deposition.

The alumina scale is preferably developed by thermal oxidation of the aluminum containing alloy prior to or during the application of the ceramic TBC layer. Oxidation is preferably performed in an atmosphere of low oxygen potential, as is know in the art.

The ceramic coatings which may be employed as thermal barrier coatings with the present invention comprise oxide ceramics and mixtures of oxide ceramics. Specifically, fully or partially stabilized zirconia may be used where additions of an oxide comprising Y₂O₃, Yb₂O₃, CaO, MgO, Gd₂O₃ or other rare earth oxide, or any other suitable oxide, and mixtures thereof may be employed as stabilizers. The TBC may be applied by EBPVD (electron beam physical vapor deposition) or by plasma or flame spray techniques. EB-PVD application techniques are preferred for use on rotating parts. U.S. Pat. Nos. 4,321,311 and 5,262,245 incorporated herein by reference. As described in U.S. Pat. No. 4,321,311, ceramic coatings applied by EBPVD techniques possess a beneficial strain tolerant columnar microstructure that promotes good adhesion. A ceramic coating thickness of 3-10 mils is typical, although lesser or greater thick nesses are also possible.

The invention alloy is less dense than other relatively recently developed alloys with higher creep strength such as PWA 1484 described in U.S. Pat. No. 4,719,080. The reduced density of the invention alloy is particularly significant for rotating turbine components such as turbine blades. In some designs, turbine blades are limited by the LCF (low cycle fatigue life) properties in the root area where the blade is held in the turbine disk. Taking density in account, the invention alloy has significantly greater LCF strength capability than the alloy of U.S. Pat. No. 4,719,080, when tested in a notched LCF test at 1200 F.

The reduced density of the invention alloy also reduces the stresses imposed on the supporting turbine disk. In engine operation, the blades exert a significant centrifugal force on the disk, an effect commonly known as blade pull.

While the present invention has been described above in some detail, numerous variations and substitutions may be made without departing from the spirit of the invention or the scope of the following claims. Accordingly, it is to be understood that the invention has been described by way of illustration and not by limitation.

1. A nickel base superalloy in weight percent consisting essentially of:
about 7.5 to about 12.5% Cr;
about 4.5 to about 5.5% Al;
up to about 2% Ti;
about 3.5 to about 4.5% W;
about 11.5-12.5% Ta;
about 3-16% Co;
about 0.2 to about 0.5% Hf
no intentional addition of Y, and less than 300 ppm;
no intentional addition of Zr, and less than 500 ppm;
up to about 0.05% C;
up to about 0.005% B;
up to about 8.5% of additional elements selected from the group consisting of Mo, Re, Nb and V;
balance essentially Ni; and wherein
P=−200 Cr+80 Mo²−250 Ti²−50 (Ti×Ta)+15 Cb+200 W−14 W²+30 Ta−1.5 Ta²+0.5 Co+1200 Al−100 Al²+100 Re+1000 Hf−2000 Hf²+700 Hf³−2000 V−500 C−15000 B−500 Zr, wherein P is less than about 2500, and wherein the alloy has oxidation resistance at least about 25% greater than an alloy having a nominal composition of 10% Cr, 5% Co, 4% W, 1.5% Ti, 5% Al, balance Ni.

2. An alloy as in claim 1 wherein the quantity Al+Ti+0.2 Ta (in wt %) ranges from 7-10%, and the quantity W+0.8 Ta ranges from 12-18%.

3. An alloy as in claim 1 wherein C is less than 0.05%, B is less than 0.005%, Zr is less than 0.5% and Y is less than 30 ppm.

4. An alloy as in claim 1, wherein P is less than about 1800.

5. An alloy as in claim 1, wherein Y is less than 50 ppm, and the additional elements selected from the group consisting of Mo, Re, Nb and V is less than 1.

6. A nickel base superalloy composition consisting essentially of:
A nickel base superalloy in weight percent consisting essentially of:
about 9 to about 11% Cr;
about 4.75 to about 5.25% Al;
about 1 to about 2% Ti;
about 3.5 to about 4.5% W;
about 11.5-12.5% Ta;
about 4-6% Co;
about 0.25 to about 0.45% Hf
no intentional addition of Y, and less than 300 ppm;
no intentional addition of Zr, and less than 300 ppm;
up to about 0.01% C;
up to about 0.005% B;
up to about 8.5% of additional elements selected from the group consisting of Mo, Re, Nb and V;
balance essentially Ni; and wherein
P=−200 Cr+80 Mo²−250 Ti²−50 (Ti×Ta)+15 Cb+200 W−14 W²+30 Ta−1.5 Ta²+0.5 Co+1200 Al−100 Al²+100 Re+1000 Hf−2000 Hf²+700 Hf³−2000 V−500 C−15000 B−500 Zr, wherein P is less than about 2500, and wherein the alloy has oxidation resistance at least about 25% greater than an alloy having a nominal composition of 10% Cr, 5% Co, 4% W, 1.5% Ti, 5% Al, balance Ni.

7. A composition as in claim 6 where in the quantity Al+Ti+0.2 Ta (in wt %) ranges from 7-10, and the quantity W+0.8 Ta (in wt. %) ranges from 12-18%.

8. A composition as in claim 6 wherein C is less than 0.05%, B is less than 0.005%, Zr is less than 0.05%, and Y is less than 0.003%.

9. A superalloy article as in claim 1 having a single crystal microstructure.

10. A superalloy article as in claim 1 having a columnar microstructure.

11. A single crystal superalloy gas turbine engine blade which comprises:
a. about 7.5 to about 12.5% Cr;
about 4.5 to about 5.5% Al;
up to about 2% Ti;
about 3.5 to about 4.5% W;
about 11.5-12.5% Ta;
about 3-16% Co;
about 0.2 to about 0.5% Hf
no intentional addition of Y, and less than 300 ppm;
no intentional addition of Zr, and less than 500 ppm;
up to about 0.05% C;
up to about 0.005% B;
up to about 8.5% of additional elements selected from the group consisting of Mo, Re, Nb and V;
balance essentially Ni; and wherein
P=−200 Cr+80 Mo²−250 Ti²−50 (Ti×Ta)+15 Cb+200 W−14 W²+30 Ta−1.5 Ta²+0.5 Co+1200 Al−100 A12+100 Re+1000 Hf−2000 Hf²+700 Hf³−2000 V−500 C−15000 B−500 Zr, wherein P is less than about 2500, and wherein the alloy has oxidation resistance at least about 25% greater than an alloy having a nominal composition of 10% Cr, 5% Co, 4% W, 1.5% Ti, 5% Al, balance Ni;
b. an aluminum containing coating on the substrate, the coating being capable of forming a durable adherent alumina scale,
c. a ceramic thermal barrier coating adhering to said alumina scale.

12. A gas turbine blade as in claim 11 wherein said thermal barrier coating has a columnar microstructure.

13. A gas turbine blade as in claim 11, wherein the aluminum containing coating is an overlay coating.

14. A gas turbine blade as in claim 11, wherein the aluminum containing coating is an aluminide.
